(19) United States
(12) Patent Application Publication
(10) Pub. No.: US 2006/0210813 A1
(43) Pub. Date: Sep. 21, 2006

(54) Coating method

(76) Inventors: Andreas Fath, Haslach (DE); Martin Surm, Schramberg (DE); Armin Waidele, Alpirsbach (DE)

Correspondence Address: DUANE MORRIS, LLP;IP DEPARTMENT, 30 SOUTH 17TH STREET, PHILADELPHIA, PA, 19103-4196, US

(21) Appl. No.: 10/543,338

(22) PCT Filed: Jan. 27, 2004
(86) PCT No.: PCT/EP04/00656

§ 371 Date: Apr. 18, 2006

(30) Foreign Application Priority Data
Jan. 27, 2003 (DE) 103 03 648.2
Jan. 27, 2003 (DE) 103 03 649.0
Jan. 27, 2003 (DE) 103 03 650.4

(51) Int. Cl. C25D 5/12; C25D 5/10; B32B 15/04

(52) U.S. Cl. 428/457; 205/181; 205/182

(57) ABSTRACT

The invention relates to a method for coating objects, particularly sanitary ware such as plumbing fixtures, shower fittings and the like, during which at least one layer made of copper, nickel or of a copper-nickel alloy is firstly applied to the object. The object itself and/or at least the uppermost applied layer are/is then subjected to a mechanical surface treatment, and at least one nickel-tungsten layer and/or at least one palladium-nickel layer are/is applied to the object or the surface-treated layer. The surface treatment preferably ensues by brushing and/or blasting. This enables objects to be provided with a specific appearance, particularly a high-grade steel-like appearance.

The invention relates to a method for coating objects, particularly sanitary ware such as plumbing fixtures, shower fittings and the like, and also to the objects which can be produced by this method.

For some time already, a wide variety of objects have been coated with inorganic or organic substances for various reasons. The reason for these coatings is, on the one hand, that of functional requirements, for example corrosion protection, or, on the other hand, that of decorative requirements, for example the visual appearance. Often, objects are coated both for functional reasons and for decorative reasons.

Of special significance are coatings for all types of sanitary ware, particularly plumbing fixtures. This is so because these must on the one hand satisfy functional requirements, i.e. be highly corrosion-resistant, easy to clean and scratch-resistant, to name just a few of these requirements. On the other hand, they must satisfy high decorative demands, i.e. glossy or mat surfaces with a specific “appearance” must be provided for example. In order to satisfy these requirements, a wide variety of metals are used as coating materials, often applied by electrodepositing onto the corresponding base bodies. A known example here is the application of chromium, with glossy surfaces of high corrosion resistance being obtained.

The problems occurring in the coating of objects, in particular in sanitary engineering, arise especially in the case of objects made of metal or with metal surfaces, but also in the case of those made of plastic or with plastic surfaces. For instance, on the one hand, certain metals either cannot be used at all, or can only be used in a coated form for certain applications on account of their properties or for reasons of cost. On the other hand, plastics, by contrast with metals, have a very low thermal capacity. Therefore, a mechanical surface treatment of metalized plastic parts is possible only to a restricted extent, since otherwise the (particularly electrodeposited) metal layers can be detached again from the plastic surfaces by the heat introduced into the plastic part as a result of the mechanical treatment. This can lead to high reject rates in industrial production.

Furthermore, it is intended that specific “appearances” can be created on all base bodies. This applies especially to the so-called “high-grade steel-like appearance”. In the case of such a configuration, the coated metal part or the metal-coated plastic part is intended to have the visual appearance of a high-grade steel surface, particularly a brushed high-grade steel surface, even if this part is not produced from high-grade steel or coated with high-grade steel. For instance, plumbing fixtures are in many cases produced from brass, zinc diecasting or other metals and subsequently coated, particularly with metals. Plumbing fixtures, shower fittings or at least the parts belonging to such fixtures, such as joining parts, roses or connecting parts, are also frequently produced from plastic and subsequently coated (with metals). All these parts are then intended to have the mentioned “high-grade steel-like appearance”.

There are in the prior art already various approaches to preparing surfaces of a specific appearance on plastic objects. For instance, the desired surface is often imitated by a painting method. In this case, the paint contains for example aluminum pigments, which are appropriately colored by the addition of dyes. The surfaces obtained thereby are often not satisfactory with respect to the visual appearance and functional properties such as scratch resistance.

In the case of another procedure, a copper layer applied to the plastic part is brushed and subsequently nickel-plated. This nickel layer is subsequently provided with a transparent protective varnish. The disadvantage of this method is that, if the varnish layer is damaged, the corrosion protection is also lost.

As an alternative to the stated painting methods, high-grade steel or a layer similar to high-grade steel can also be applied to mat chromium-plated plastic parts in a vacuum (PVD method). Although the resulting surface then has the color of high-grade steel, it does not have the typical surface structure of brushed high-grade steel. A further disadvantage is that the application of metal layers by the PVD method is very expensive.

The invention therefore sets itself the problem, inter alia, of providing a coating method for objects, particularly sanitary ware, in which a specific visual appearance of the coated object can be deliberately achieved. In particular, with the invention it is intended to obtain a method for providing a coated object with the visual appearance of brushed high-grade steel. In this case, the coated object with this appearance is intended to satisfy the functional requirements demanded of it, in particular in sanitary engineering.

This problem is solved by the method with the features of claim 1 and by the object with the features of claim 12. Preferred embodiments of this method and this object are presented in the dependent claims 2 to 11 and 13 to 41. The wording of all the claims is hereby made the content of this description by reference.

The method mentioned at the beginning is distinguished according to the invention by the fact that optionally at least one layer of copper, nickel or a copper-nickel alloy is applied to the object. The object and/or at least the uppermost applied layer is mechanically surface-treated. Then, at least one nickel-tungsten layer and/or at least one palladium-nickel layer is applied over the surface-treated layer.

The aforementioned surface treatment preferably takes place in this case by brushing and/or blasting. In this case, it is further preferred if the surface treatment in any event takes place at least partly by brushing. Polishing may also be mentioned as a preferred surface treatment.

Brushing is to be understood here as meaning a mechanical surface treatment in which the surface is worked with a brush or equivalent means of adequate strength and hardness for working, with partial removal of the metal layer. By this process, the characteristic structures such as grooves, depressions and the like, as are characteristic of such working with brushes known to a person skilled in the art, are worked into the surface. In this case, it goes without saying that the brushed metal layer concerned is optionally not removed completely.

As is known, blasting is understood by a person skilled in the art as meaning a mechanical surface treatment in which, for example, (quartz) sand or glass beads are fired onto the corresponding surface as blasting shot (diameter usually 0.5 to 1.5 mm) with the aid of compressed-air blowers. The surface structures characteristic of blasting are thereby created.

As already mentioned, in the case of the invention the brushing and blasting can be used as alternatives or in combination. Preferably, at least part of the surface to be treated is brushed, particularly those parts of the surface that can only be reached and worked with the brush/brush wheel with difficulty then being blasted.

The applied layers of copper, nickel or copper-nickel alloys are preferably formed according to the invention in a comparatively “soft” state, in order that a simple mechanical surface treatment, in particular by brushing, is made possible. Copper layers, particularly electrodeposited copper layers, are usually adequately soft. In the case of nickel layers, so-called sulfamate nickel (known to a person skilled in the art), which is deposited from a nickel bath on a sulfamate basis (without organic additives) as a soft mat nickel, is to be emphasized in this connection as preferred.

The method according to the invention is preferably set up in such a way that firstly a copper layer is applied to the object and then a nickel layer. This nickel layer is then mechanically surface-treated, preferably brushed and/or blasted.

The nickel layers are, according to the invention, particularly so-called sulfamate nickel layers, i.e. soft mat nickel layers, as are known to a person skilled in the art.

According to the invention, it is further preferred if, before application of the nickel-tungsten layer or palladium-nickel layer, at least one further layer of copper, nickel or a copper-nickel alloy is applied to the surface-treated object/base body or to the surface-treated layer. Such further layers may, depending on the metal used, increase the corrosion resistance or induce special visual effects on the coated object finally obtained. The further layer is preferably a nickel layer, particularly a so-called sulfamate nickel layer.

As already partly evident from the previous statements, according to the invention the layers of the stated metals are preferably obtained at least partly by electrodepositing, i.e. by depositing from an electrolyte under a current flow. Preferably, all the metal layers applied to the object are electrodeposited. In this case, a plastic object that is not in itself conductive is made conductive by methods known to a person skilled in the art. For example, the plastic surface is electrolessly activated with palladium and electrolessly metalized with nickel. A so-called pre-nickel layer can optionally be applied to the thin nickel layer obtained in this way by depositing under a current flow. The base structure obtained in this way is then further treated according to the invention.

In a development, it is preferred in the case of the method according to the invention if at least one siloxane or polysiloxane top layer is then applied over the (optionally uppermost) nickel-tungsten layer or palladium-nickel layer. It is known that siloxanes/polysiloxanes are obtained from organosilanes, for example by thermal treatment. Particularly suited for this is the so-called sol-gel method, which leads to the polysiloxane layers that are also known in the literature under the keyword “sol-gel coatings”. Such a top layer brings about additional sealing of the surface and can improve its physical and chemical properties (for example with respect to abrasion resistance, corrosion resistance, a repellent effect for liquids and the like). Although polysiloxane layers pigmented in a suitable way are possible according to the invention, the top layer will generally be a transparent polysiloxane layer.

It goes without saying that the object to be coated can be subjected to a customary pretreatment before carrying out the method according to the invention. Such pretreatment steps are known to a person skilled in the art. To be mentioned here are the customary chemical and/or physical methods, which can be cited under the keywords anodic degreasing, cathodic degreasing, hot degreasing, ultrasonic degreasing and the like. It goes without saying that such known pretreatment and activation steps can also be used between the individual method steps, for example before the application of further metal layers.

The object according to the invention, i.e. preferably the sanitary ware according to the invention such as a plumbing fixture, shower fitting and the like, comprises according to the invention a base body. On this base body there is optionally at least one layer of copper, nickel or a copper-nickel alloy. The base body and/or optionally the uppermost layer is mechanically surface-treated. Over the surface-treated base body or the uppermost (surface-treated) layer there is then at least one nickel-tungsten layer and/or at least one palladium-nickel layer. Depending on the embodiment, the base body consists of metal or has metal surfaces (not high-grade steel) or consists of plastic or has plastic surfaces.

The base body or the uppermost layer on which the nickel-tungsten layer and or palladium-nickel layer is located is particularly brushed and/or blasted. With respect to the surface structures thereby defined, reference is expressly made to the above statements. Polishing is also possible.

In a development, in the case of the object according to the invention there is preferably at least one further layer of copper, nickel or a copper-nickel alloy between the surface-treated base body or the surface-treated layer and the nickel-tungsten layer or palladium-nickel layer.

In accordance with the previous statements, preferred objects according to the invention can accordingly be characterized by the following construction:

1. Object with

a base body of metal or a base body with metallic surfaces (not high-grade steel), this base body being mechanically surface-treated, preferably brushed, and
a nickel-tungsten layer on the surface-treated base body.
   2. Object with
a base body of metal or a base body with metallic surfaces (not high-grade steel), this base body being mechanically surface-treated, preferably brushed, and
a nickel layer, preferably sulfamate nickel layer, on the surface-treated base body, and
a palladium-nickel layer located on the nickel layer.
   3. Object with
a base body of metal or a base body with metallic surfaces (not high-grade steel),
a layer of copper or nickel located on the base body,
   this copper layer or nickel layer being mechanically surface-treated, preferably brushed, and
a nickel-tungsten layer and/or palladium-nickel layer on the surface-treated copper layer or nickel layer.
   4. Object with
a base body of metal or a base body with metallic surfaces (not high-grade steel),
a copper layer located on the base body,
a nickel layer located on the copper layer,
   this nickel layer being mechanically surface-treated, preferably brushed, and
a nickel-tungsten layer and/or a palladium-nickel layer on the surface-treated nickel layer.

In the case of the objects defined under 4., between the surface-treated nickel layer and the nickel-tungsten layer or palladium-nickel layer there may preferably be a further nickel layer.

5. Object with

a base body of plastic or a base body with plastic surfaces,
a layer of copper or nickel located on the base body,
   this copper layer or nickel layer being mechanically surface-treated, preferably brushed, and
a nickel-tungsten layer on the surface-treated copper layer or nickel layer.
   6. Object with
a base body of plastic or a base body with plastic surfaces,
a copper layer located on the base body,
a nickel layer located on the copper layer,
   this nickel layer being mechanically surface-treated, preferably brushed, and
a nickel-tungsten layer on the surface-treated nickel layer.
   7. Object with
a base body of plastic or a base body with plastic surfaces,
a layer of copper or nickel located on the base body,
   this copper layer or nickel layer being mechanically surface-treated, preferably brushed, and
a palladium-nickel layer on the surface-treated copper layer or nickel layer.
   8. Object with
a base body of plastic or a base body with plastic surfaces,
a copper layer located on the base body,
a nickel layer located on the copper layer,
   this nickel layer being mechanically surface-treated, preferably brushed, and
a palladium-nickel layer on the surface-treated nickel layer.

In the case of all the objects defined under 3. and 4., the surface-treated nickel layer may preferably be a so-called sulfamate nickel layer. Such nickel layers are known to a person skilled in the art as soft mat nickel layers. The copper layers mentioned under 3. and 4. are preferably mat copper layers.

In the case of the objects defined under 6. and 8., between the surface-treated nickel layer and the nickel-tungsten/palladium-nickel layer there may preferably be a further nickel layer.

In the case of all the objects defined under 5. to 8., the surface-treated nickel layer may preferably be a so-called sulfamate nickel layer. Such nickel layers are known to a person skilled in the art as soft mat nickel layers. The copper layers mentioned under 5. to 8. are preferably mat copper layers.

If further nickel layers are present (between the surface-treated base body or surface-treated layer and the nickel-tungsten layer or palladium-nickel layer), they are preferably likewise so-called sulfamate nickel layers.

In the case of all the embodiments according to the invention of the object according to the invention, over the (optionally uppermost) nickel-tungsten layer or palladium-nickel layer there may be a (at least one) siloxane-polysiloxane top layer.

Accordingly, a particularly preferred object according to the invention is defined by the following construction:
a base body of metal or a base body with metallic surfaces,
a copper layer located on the base body,
a nickel layer located on the copper layer, preferably a sulfamate nickel layer, which is mechanically surface-treated, preferably brushed,
a further nickel layer, preferably a sulfamate nickel layer, located on the surface-treated nickel layer,
a nickel-tungsten layer and/or palladium-nickel layer located on this further nickel layer, and
a polysiloxane top layer located on the nickel-tungsten layer and/or palladium-nickel layer.

A further particularly preferred object according to the invention is defined by the following construction:
a base body of plastic or a base body with plastic surfaces,
a copper layer located on the base body,
a nickel layer, located on the copper layer, preferably a sulfamate nickel layer, which is mechanically surface-treated, preferably brushed,
a further nickel layer, preferably a sulfamate nickel layer, located on the surface-treated nickel layer,
a nickel-tungsten layer located on this further nickel layer, and
a polysiloxane top layer located on the nickel-tungsten layer.

A further particularly preferred object according to the invention is defined by the following construction:
a base body of plastic or a base body with plastic surfaces,
a copper layer located on the base body,
a nickel layer located on the copper layer, preferably a sulfamate nickel layer, which is mechanically surface-treated, preferably brushed,
a further nickel layer, preferably a sulfamate nickel layer, located on the surface-treated nickel layer,
a palladium-nickel layer located on this further nickel layer, and
a polysiloxane top layer located on the palladium-nickel layer.

In principle, nickel-tungsten layers of any desired alloy composition can be used in the invention. Preferably, however, the tungsten fraction is between 25 and 45 atomic percent, particularly between 30 and 40 atomic percent.

In principle, palladium-nickel layers of any desired alloy composition can be used in the invention. Preferably, however, the palladium fraction is at least 50 atomic percent, particularly at least 70 atomic percent. Further preferred is a palladium fraction of about 80 atomic percent. The emphasized high palladium fractions have the effect that the layers obtained have a particularly good corrosion resistance, which may even be greater than in the case of high-grade steel.

In principle, the layer thicknesses of the coatings applied to the object are not critical. However, to be able to perform their function particularly well, there are preferred ranges for these corresponding layer thicknesses. For instance, the layer thickness of the first metal layer located on the object is between 10 μm and 60 μm, preferably between 20 μm and 50 μm. Within this last-mentioned range, layer thicknesses of between 20 μm and 40 μm are further preferred.

The layer thickness of the nickel layers, preferably the (further) nickel layers located on a surface-treated layer, is preferably between 5 μm and 25 μm, preferably between 5 μm and 15 μm. Here, within the last-mentioned range, layer thicknesses of between 6 μm and 10 μm are to be particularly emphasized.

The layer thicknesses of the nickel-tungsten layer(s) or palladium-nickel layer(s) are likewise not critical, but are chosen to be as small as possible (for example less than 20 μm). For instance, layer thicknesses of between 0.1 μm and 5 μm are to be emphasized. Within this range, layer thicknesses of between 0.2 μm and 2 μm, particularly between 0.5 μm and 1 μm, are further preferred.

The layer thickness of the siloxane/polysiloxane layer(s) is preferably less than 5 μm, particularly less than 1 μm.

In principle, all known and in particular customarily industrially used metals (with the exception of high-grade steel) can be coated according to the invention. In this case, the object may either consist itself of the corresponding metal, or the metal may form at least part of the surface of this object. Preferably, base bodies of metals such as are used in sanitary engineering are used in the case of the invention. To be emphasized here are base bodies of aluminum, zinc (diecasting) and particularly brass.

In principle, all known and in particular customarily industrially used (electroplatable) plastics can be coated according to the invention. In this case, the object may either consist itself of the corresponding plastics material, or the plastics material may form at least part of the surface of this object. Preferably, base bodies of plastics such as are used in sanitary engineering are used in the case of the invention. In particular, the plastic here is ABS (acrylonitrile-butadiene-styrene copolymer). PA (polyamide) and ABS/PC (ABS copolymer with polycarbonate) are also to be emphasized.

In accordance with the problem set at the beginning, the object according to the invention preferably has a so-called high-grade steel appearance, i.e. a high-grade steel-like appearance for the viewer. This high-grade steel appearance is preferably that of “brushed high-grade steel”.

The method according to the invention and the object according to the invention provide a solution to the problem explained at the beginning. The object according to the invention satisfies both the functional requirements demanded of it and the decorative requirements demanded of it, particularly if it is an object of sanitary ware. Therefore, on the one hand, inter alia, the object is corrosion-resistant, abrasion-resistant, allows liquids to be repelled well and has firmly adhering surface layers. On the other hand, it conveys to the buyer/user the desired appearance, particularly a high-grade steel appearance, so that objects coated in this way are visually indistinguishable from objects made of solid high-grade steel or from objects actually coated with high-grade steel.

Furthermore, the invention comprises an electrolyte for the electrodepositing of nickel-tungsten surfaces, particularly sanitary ware such as plumbing fixtures. According to the invention, this electrolyte contains
sodium tungsten dihydrate (Na₂WO₄·2H₂O),
nickel sulfate hexahydrate (NiSO₄·6H₂O),
at least one complexing agent containing citric acid, preferably trisodium citrate dihydrate and/or citric acid monohydrate,
ammonium chloride (NH₄Cl), and
optionally further additives.

The aforementioned additives may be any of the customary additives that are used for electrodepositing in the corresponding baths or electrolytes. They may be, for example, gloss producing additives, wetting agents, surfactants and the like. Such additives may be used in various quantities, depending on the intended use.

It is preferred according to the invention if specific quantitative ranges of the aforementioned constituents of the electrolyte are maintained. For instance, the sodium tungsten dihydrate is preferably contained in the electrolyte in quantities of between 80 g/l and 140 g/l, particularly 80 g/l and 100 g/l. The nickel sulfate hexahydrate is preferably present in the electrolyte in quantities of between 25 g/l and 50 g/l, particularly 25 g/l and 35 g/l. For the complexing agent containing citric acid, quantities of between 90 g/l and 150 g/l, particularly 100 g/l and 120 g/l (preferably as citric acid monohydrate) are to be emphasized and, for the ammonium chloride, likewise acting as a complexing agent, quantities of between 15 g/l and 30 g/l, particularly 15 g/l and 20 g/l, are to be emphasized. Optionally present gloss producing additives are preferably present in quantities of between 0 and 20 g/l. For wetting agents, preferred quantitative ranges are to be given as between 0 and 1 g/l, particularly between 0.1 and 0.3 g/l, for surfactants from 0 to 2 g/l.

The electrolyte according to the invention preferably has a pH of between 7.5 and 8.5, with pHs of between 7.6 and 8.2 being preferred.

Finally, the invention comprises a method for electrodepositing nickel-tungsten surfaces, particularly on sanitary ware such as shower fittings. In the case of this method, the nickel-tungsten layers are deposited from an electrolyte, to be precise preferably from the electrolyte according to the invention described above. In this case, current densities of between 0.5 and 3 A/dm² and temperatures >40° C., particularly between 50° C. and 60° C., are applied. Preferably, to improve the depositing behavior, the objects to be coated can be moved in the electrolyte during the depositing process, it being possible in particular for movements of between 0 and 1 m/s to be used.

The stated and further features of the invention are evident from the description of the examples which now follows in conjunction with the claims. In this respect, the individual features can in each case be realized by themselves alone or in combination with one another.

### EXAMPLES

A. For the Coating of Sanitary Ware, Objects of a Brass Fixture or Fitting are Prepared.

With such brass base bodies, the following coating methods are carried out:
In the first case, the brass base body (in the polished state) is directly subjected to a mechanical surface treatment, to be specific is brushed and sand-blasted. Then, the nickel-tungsten layer is applied directly to the base body surface-treated in this way.
In the second case, the brass base body (in the polished state) is likewise directly brushed and sand-blasted. Then, a sulfamate nickel layer is initially applied to the surface-treated base body and then a palladium-nickel layer is applied to this nickel layer.
In the third case, initially a copper layer is applied to the brass base body (in the polished state) and then a sulfamate nickel layer is applied. The nickel surface obtained in this way is subsequently brushed and sand-blasted. After the mechanical surface treatment, a further sulfamate nickel layer is electrodeposited onto the brushed/sand-blasted surface. Then, either a nickel-tungsten layer or a palladium-nickel layer is applied to this nickel layer.

In all cases, a commercially obtainable brush wheel, which is suitable for applying a brushing structure typical of high-grade steel parts with the corresponding grooves, depressions and the like, is used for the brushing. Those locations of the brass base body which cannot be worked well with the brush wheel, such as for example narrow transitions, are worked by sand-blasting.

The nickel-tungsten layers obtained in the first and third cases are electrodeposited from a corresponding electrolyte. The thickness of the nickel-tungsten layers is about 1 μm. The tungsten fraction of these layers is around 40 atomic percent.

The sulfamate nickel layers applied in cases two and three are electrodeposited with layer thicknesses of about 10 μm from a corresponding electrolyte. The copper layers applied first in the third case are likewise obtained electrolytically from a corresponding electrolyte with layer thicknesses of about 40 μm.

The palladium-nickel layers applied in the third case are likewise electrodeposited in layer thicknesses of about 1 μm from a corresponding electrolyte. The palladium fraction of these layers is around 80 atomic percent.

In the case of further configurations, the metal-coated parts stated above are also sealed with a polysiloxane layer (layer thickness about 0.5 μm).

In all cases, the layer construction obtained is on the one hand identical in color to that of high-grade steel, and on the other hand the (mechanically treated) surface structure obtained corresponds to that of brushed high-grade steel. Consequently, the parts coated according to the invention are visually indistinguishable from parts made of solid high-grade steel or from parts coated with high-grade steel itself.

In the cases in which a surface sealing is performed with polysiloxane, this final top layer does not influence the visual appearance and the feel of the objects according to the invention. However, outstanding liquid- and dirt-repelling properties are achieved by this top layer. The polysiloxane top layer can be applied to the objects according to the invention in a particularly simple manner on account of the brushed/sand-blasted surface structure and also adheres particularly well to these metal-coated objects.

B. For Coating an Object of Sanitary Ware, the Base Body of a Shower is Prepared from the Plastics Material ABS (acrylonitrile-butadiene-styrene copolymer).

This plastic part is electrodeposited with copper (layer thickness about 40 μm) in the customary way. A so-called sulfamate nickel layer (nickel mat) is electrodeposited onto this copper layer (layer thickness about 10 μm). The nickel surface obtained in this way is subsequently brushed and sand-blasted. A commercially obtainable brush wheel, which is suitable for applying a brushing structure typical of high-grade steel parts with the corresponding grooves, depressions and the like, is used for the brushing. Those locations of the plastic part which cannot be worked well with the brush wheel, such as for example narrow transitions, are worked by sand-blasting. After these mechanical surface treatments, a mat, well surface-structured metal-coated plastic part is obtained.

After the mechanical surface treatment, a further sulfamate nickel layer is electrodeposited onto the brushed/sand-blasted surface. In the present case, this layer has a thickness of about 8 μm.

Then, a nickel-tungsten layer about 1 μm thick is electrodeposited from an electrolyte according to the invention onto this nickel layer. The tungsten fraction of this layer is around 40 atomic percent. The electrolyte used according to the invention contains the following components:

84.6 g/l of sodium tungsten dihydrate

28.8 g/l of nickel sulfate hexahydrate

112 g/l of citric acid monohydrate

17.7 g/l of ammonium chloride.

This electrolyte is also suitable for other applications for depositing nickel-tungsten layers.

The layer construction obtained is on the one hand identical in color to that of high-grade steel, and on the other hand the (mechanically treated) surface structure obtained corresponds to that of brushed high-grade steel. Consequently, the plastic parts coated according to the invention are visually indistinguishable from parts made of solid high-grade steel or from plastic parts coated with high-grade steel.

In a final operation, the metal-coated plastic part is sealed with a polysiloxane layer (layer thickness about 0.5 μm). This final top layer does not influence the visual appearance and the feel of the object according to the invention. However, outstanding liquid- and dirt-repelling properties are achieved by this top layer. The polysiloxane top layer can be applied to the metal-coated object in a particularly simple manner on account of the brushed/sand-blasted surface structure and also adheres particularly well to this metal-coated object.

C. For Coating an Object of Sanitary Ware, the Base Body of a Shower is Prepared from the Plastics Material ABS (acrylonitrile-butadiene-styrene copolymer).

This plastic part is electrodeposited with copper (layer thickness about 40 μm) in the customary way. A so-called sulfamate nickel layer (nickel mat) is electrodeposited onto this copper layer (layer thickness about 10 μm). The nickel surface obtained in this way is subsequently brushed and sand-blasted. A commercially obtainable brush wheel, which is suitable for applying a brushing structure typical of high-grade steel parts with the corresponding grooves, depressions and the like, is used for the brushing. Those locations of the plastic part which cannot be worked well with the brush wheel, such as for example narrow transitions, are worked by sand-blasting. After these mechanical surface treatments, a mat, well surface-structured metal-coated plastic part is obtained.

After the mechanical surface treatment, a so-called sulfamate nickel layer is electrodeposited onto the brushed/sand-blasted surface. In the present case, this layer has a thickness of about 8 μm. Then, a palladium-nickel layer about 1 μm thick is electrodeposited onto this nickel layer. The palladium fraction of this layer is around 80 atomic percent, so that outstanding corrosion properties are achieved. The corrosion resistance is even better than that of high-grade steel. The layer construction obtained is on the one hand identical in color to that of high-grade steel, and on the other hand the (mechanically treated) surface structure obtained corresponds to that of brushed high-grade steel. Consequently, the plastic parts coated according to the invention are visually indistinguishable from parts made of solid high-grade steel or from plastic parts coated with high-grade steel.

In a final operation, the metal-coated plastic part is sealed with a polysiloxane layer (layer thickness about 0.5 μm). This final top layer does not influence the visual appearance and the feel of the object according to the invention. However, outstanding liquid- and dirt-repelling properties are achieved by this top layer. The polysiloxane top layer can be applied to the metal-coated object in a particularly simple manner on account of the brushed/sand-blasted surface structure and also adheres particularly well to this metal-coated object.

1-45. (canceled)

46. A method for coating objects, comprising:
(a) the object, or at least the uppermost applied layer being mechanically surface-treated; and
(b) at least one nickel-tungsten layer, or at least one palladium-nickel layer being applied to the object,
said objects being sanitary ware, including plumbing fixtures and shower fittings, wherein optionally, at least one layer of copper, nickel or a copper-nickel alloy is applied to the object.

47. The method as claimed in claim 46, wherein the objects comprise metal, excluding high-grade steel, or have metal surfaces.

48. The method as claimed in claim 46, wherein the objects comprise plastic, or have plastic surfaces.

49. The method as claimed in claim 48, wherein at least the uppermost applied layer is mechanically surface-treated.

50. The method as claimed in claim 46, wherein the surface treatment is performed by brushing or blasting.

51. The method as claimed in claim 46, wherein a copper layer, followed by a nickel layer are applied to the object, the nickel layer being mechanically surface-treated.

52. The method as claimed in claim 46, wherein the nickel layer is a sulfamate nickel layer.

53. The method as claimed in claim 46, wherein before application of the nickel-tungsten layer or the palladium-nickel layer, at least one further layer of copper, nickel or a copper-nickel alloy is applied to the surface-treated object or to the surface-treated layer.

54. The method as claimed in claim 53, wherein the further layer is a nickel layer.

55. The method as claimed in claim 46, wherein the applied metal layers are at least partly applied by electrodepositing.

56. The method as claimed in claim 46, wherein at least one siloxane or polysiloxane top layer is applied over the nickel-tungsten layer or the palladium-nickel layer.

57. A sanitary ware object, which comprises:
(a) a base body, wherein optionally, at least one layer of copper, nickel or a copper-nickel alloy are on the base body as an uppermost layer, the base body, or at least the optionally uppermost layer being mechanically surface-treated; and
(b) at least one nickel-tungsten layer or at least one palladium-nickel layer over the surface-treated base body or over the surface-treated uppermost layer.

58. The object as claimed in claim 57, wherein the object comprises metal or has metal surfaces, excluding high-grade steel.

59. The object as claimed in claim 57, wherein the object comprises plastic, or has plastic surfaces.

60. The object as claimed in claim 59, wherein at least the uppermost layer is mechanically surface-treated.

61. The object as claimed in claim 57, wherein the base body or the uppermost layer is brushed or blasted.

62. The object as claimed in claim 57, wherein there is at least one further layer of copper, nickel or a copper-nickel alloy between the surface-treated base body or the surface-treated layer and the nickel-tungsten layer or the palladium-nickel layer.

63. The object as claimed in claim 57, wherein the object comprises:
(a) a base body of metal or with metallic surfaces, excluding high-grade steel, the base body being mechanically surface-treated; and
(b) a nickel-tungsten layer on the surface-treated base body.

64. The object as claimed in claim 57, wherein the object comprises:
(a) a base body of metal or with metallic surfaces, excluding high-grade steel, the base body being mechanically surface-treated;
(b) a nickel layer on the surface-treated base body, and,
(c) a palladium-nickel layer on the nickel layer.

65. The object as claimed in claim 57, further comprising:
(a) a base body of metal or with metallic surfaces, excluding high-grade steel;
(b) a layer of copper or nickel located on the base body, the copper or nickel layer being mechanically surface-treated;
(c) a nickel-tungsten layer or a palladium-nickel layer on the surface-treated copper layer or nickel layer.

66. The object as claimed in claim 57, further comprising:
(a) a base body of metal or with metallic surfaces, excluding high-grade steel;
(b) a copper layer on the base body,
(c) a nickel layer on the copper layer, the nickel layer being mechanically surface-treated; and
(d) a nickel-tungsten layer or a palladium-nickel layer on the surface-treated nickel layer.

67. The object as claimed in claim 57, further comprising:
(a) a base body of plastic or with plastic surfaces;
(b) a layer of copper or nickel located on the base body, the copper or nickel layer being mechanically surface-treated; and
(c) a nickel-tungsten layer on the surface-treated copper layer or nickel layer.

68. The object as claimed in claim 57, further comprising:
(a) a base body of plastic or with plastic surfaces;
(b) a copper layer located on the base body;
(c) a nickel layer located on the copper layer, the nickel layer being mechanically surface-treated; and
(d) a nickel-tungsten layer on the surface-treated nickel layer.

69. The object as claimed in claim 57, further comprising:
(a) a base body of plastic or with plastic surfaces;
(b) a layer of copper or nickel located on the base body, the copper or nickel layer being mechanically surface-treated; and
(c) a palladium-nickel layer on the surface-treated copper layer or nickel layer.

70. The object as claimed in claim 57, further comprising:
(a) a base body of plastic or with plastic surfaces;
(b) a copper layer on the base body;
(c) a nickel layer on the copper layer, the nickel layer being mechanically surface-treated; and
(d) a palladium-nickel layer on the surface-treated nickel layer.

71. The object as claimed in claim 57, wherein an additional nickel layer is between the surface-treated nickel layer and the nickel-tungsten layer or palladium-nickel layer.

72. The object as claimed in claim 71, wherein the surface-treated nickel layer is a sulfamate nickel layer.

73. The object as claimed in claim 71, wherein the additional nickel layer between the surface-treated nickel layer and the nickel-tungsten layer or palladium-nickel layer is a sulfamate nickel layer.

74. The object as claimed in claim 57, wherein a siloxane or polysiloxane top layer is over the nickel-tungsten layer or palladium-nickel layer.

75. The object as claimed in claim 74, further comprising:
(a) a base body of metal or with metallic surfaces;
(b) a copper layer on the base body;
(c) a mechanically surface-treated nickel layer on the copper layer;
(d) an additional nickel layer on the surface-treated nickel layer;
(e) a nickel-tungsten layer or palladium-nickel layer on the additional nickel layer; and
(f) a siloxane/polysiloxane top layer on the nickel-tungsten layer or palladium-nickel layer.

76. The object as claimed in claim 74, further comprising:
(a) a base body of plastic or with plastic surfaces;
(b) a copper layer on the base body;
(c) a mechanically surface-treated nickel layer on the copper layer;
(d) an additional nickel layer on the surface-treated nickel layer;
(e) a nickel-tungsten layer on the additional further nickel layer; and
(f) a siloxane/polysiloxane top layer on the nickel-tungsten layer.

77. The object as claimed in claim 74, further comprising:
(a) a base body of plastic or with plastic surfaces;
(b) a copper layer on the base body;
(c) a mechanically surface-treated nickel layer on the copper layer;
(d) an additional nickel layer on the surface-treated nickel layer,
(e) a palladium-nickel layer on the additional nickel layer; and
(f) a siloxane/polysiloxane top layer on the palladium-nickel layer.

78. The object as claimed in claim 57, wherein the tungsten fraction of the nickel-tungsten layer is between 25 and 45 atomic percent.

79. The object as claimed in claim 57, wherein the palladium fraction of the palladium-nickel layer is at least 50 atomic percent.

80. The object as claimed in claim 57, wherein the layer thickness of the surface-treated uppermost layer is between 10 μm and 60 μm.

81. The object as claimed in claim 57, wherein the layer thickness of the nickel layers is between 5 μm and 25 μm.

82. The object as claimed in claim 57, wherein the layer thickness of the nickel-tungsten layers or palladium-nickel layers is between 0.1 μm and 5 μm.

83. The object as claimed in claim 57, wherein the layer thickness of the siloxane/polysiloxane layer is less than 5 μm.

84. The object as claimed in claim 57, wherein the metal is brass.

85. The object as claimed in claim 57, wherein the plastic is ABS.

86. The object as claimed in claim 57, wherein the object has a high-grade steel appearance.

87. An electrolyte for the electrodepositing of nickel-tungsten surfaces, comprising:
(a) sodium tungsten dihydrate;
(b) nickel sulfate hexahydrate;
(c) at least one complexing agent containing citric acid; and
(d) ammonium chloride.

88. The electrolyte as claimed in claim 87, wherein the electrolyte contains
(a) 80 g/l to 140 g/l of sodium tungsten dihydrate;
(b) 25 g/l to 50 g/l of nickel sulfate hexahydrate;
(c) 90 g/l to 150 g/l of complexing agent containing citric acid; and
(d) 15 g/l to 30 g/l of ammonium chloride.

89. The electrolyte as claimed in claim 87, wherein the electrolyte has a pH of between 7.5 and 8.

90. The method as recited in claim 55, wherein the electrodepositing is performed at a current density of from 0.5 to 3 A/dm² and a temperature of from 40° C. to 60° C.
